(19) United States
(12) Patent Application Publication
(10) Pub. No.: US 2006/0159119 A1
(43) Pub. Date: Jul. 20, 2006

(54) DSL detector

(76) Inventors: Philip Ted Kortum, Austin, TX (US); Marc Andrew Sullivan, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/037,816

(22) Filed: Jan. 18, 2005

(51) Int. Cl. H04L 12/66

(52) U.S. Cl. 370/463

(57) ABSTRACT

A DSL sync detector indicates whether or not DSL sync is present on a telephone line. The detector facilitates DSL self-installation by indicating to a subscriber that the subscriber may proceed with the self-installation of DSL because DSL sync has been detected on the subscriber's telephone line. Specific embodiments provide a detector that plugs into a telephone jack and that has a telephone pass-through port so that a telephone may be plugged into the jack while the customer waits for DSL sync to be present. The detector is a useful component of a DSL self-installation kit to prevent failed self-installations that result from attempting a DSL self-installation before DSL sync is present on the line.

### FIELD OF THE INVENTION

The present invention relates to the internet, and in particular to a Digital Subscriber Line “sync” detector for high-speed internet access.

### BACKGROUND OF THE INVENTION

Digital Subscriber Line (DSL) refers to a family of technologies that provide a digital connection over the copper wires of the local telephone network. It allows an ordinary phone line to provide digital communication without blocking access to voice services.

The telephone system was designed to transmit over a frequency range from around 300 Hz to 3 to 4 kHz. The local loop of copper telephone connections to individual subscribers, however, can usually communicate using a much wider range of frequencies, ranging from these low frequencies up to 200-800 kHz, depending on the quality of the circuit and the sophistication of the equipment. DSL services were devised as a means of overcoming the restriction on the amount of data that could be transmitted over a wireline.

DSL services often reserve the 0.3-4 kHz band for voice calls over the “plain old telephone service” (POTS). The frequencies above and below this range, however, can be used to transmit data. A DSL connection takes place between equipment of the subscriber and the telephone exchange, with some other protocol used between the exchange and whoever the subscriber really wants to connect to, typically an Internet service provider. This differs from a normal telephone connection, where the public telephone network links subscribers to each other.

DSL installation problems typically occur in two main categories: (1) problems where a DSL customer's modem has “sync;” and (2) problems where a DSL customer's modem does not have “sync”. The present invention provides a solution these common DSL installation problems.

### BRIEF DESCRIPTION OF THE DRAWINGS

The present invention is further described in the detailed description that follows, by reference to the noted drawings, by way of non-limiting examples of embodiments of the present invention, in which reference numerals represent the same parts throughout the several views of the drawings, and in which:

FIG. 1 is an isometric schematic drawing of a DSL indicator of a specific embodiment of the present invention.

FIG. 2 is a front view schematic drawing of the DSL indicator of FIG. 1.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to DSL self-installation. It is understood, however, that DSL self-installation is merely an example of a specific embodiment of the present invention, which is directed broadly to DSL sync detection, within the scope of the invention. The terminology, examples, drawings and embodiments, therefore, are not intended to limit the scope of the invention.

The subscriber end of the connection consists of a DSL modem. This converts data from the digital electronic pulses used by computers into a digital audio stream of a suitable frequency range for the particular DSL variant in use. In addition the subscriber may need to install a passive electronic filter (known variously as a “filter”, “micro-filter” or a “splitter”) if using the POTS service on the same line (and possibly also to improve the DSL termination and prevent echoes). A filter ensures that the DSL modem and the telephone only receive the frequencies they are designed to handle. Subscribers can plug a filter into an existing telephone socket when using a “wires-only” service.

At the exchange, a digital subscriber line access multiplexer (DSLAM) terminates the DSL circuits and aggregates them, where they are handed off to other networking transports. It also separates out the voice component.

The reach-restraints (line length from central office to subscriber) diminish as data rates increase. Technologies such as VDSL provide short-range links (typically “fiber to the curb” network scenarios). Example DSL technologies (sometimes called xDSL) include:

ADSL (Asymmetric Digital Subscriber Line);

HDSL (High Bit Rate Digital Subscriber Line);

RADSL (Rate Adaptive Digital Subscriber Line);

SDSL (Symmetric Digital Subscriber Line, a standardized version of HDSL);

VDSL (Very high speed Digital Subscriber Line); and

G.SHDSL (ITU-T Standardized replacement for early proprietary SDSL).

DSL installation problems can be separated into two main categories: (1) problems where a DSL customer's modem has “sync;” and (2) problems where a DSL customer's modem does not have “sync”. “Sync” refers to the synchronization between the DSL modem and DSL equipment at the telephone company's central office. Sync is usually indicated by a light on the DSL modem.

Sync detector/indicator devices are well known to those of ordinary skill in the art. Below is partial list of DSL modem brands and the respective DSL sync indicator designation of each brand:

LinkMAX HSA300A-2: Sync/PPPoE light

Westel Wirespeed: READY light

DQ VisionNet 200ES, 200ER: ADSL light

Cayman 3220-H: Status light

Alcatel 1000: Power/Sync light

Alcatel SpeedTouch Home: Line/Sync light

Efficient Networks

SpeedStream 5260: DSL Light

Note that in the examples above, DSL is installed first, either by the customer or the DSL provider, so that the sync detector/indicator of the DSL modem operates after the fact of installation. The present invention, in contrast, provides a device that allows a new DSL subscriber to detect the presence or absence of a DSL signal on a line before performing a DSL self-installation.

For the purposes of the present disclosure, it will be understood the terms “detector” and “indicator” may be used interchangeably or that either term may be used as shorthand to also include the other, as will be evident from the context. That is, to avoid over-use of a construct such as “detector/indicator” and the like, to refer to the ostensibly separate functions of detection (is sync present or not?) and indication (light, LED, or some other signal) to show the result of the detection, the terms are used interchangeably because the functions are so intertwined.

Connecting a customer to DSL involves 4 basic steps:

1) The customer orders DSL for his service provider;

2) The service provider provisions the DSL line to the home;

3) The service provider ships the customer a kit that contains hardware and software necessary to perform DSL self-installation; and

4) The customer performs the DSL self-installation

The sequence must be followed as specified, however, or the installation will fail. Frequently, as is evidenced by trouble call logs into the DSL help, the customer tries to perform the installation before the DSL line is provisioned to the home. If the user attempts to do this, the installation will fail.

Self-installation failure occurs for many reasons; chief among them is the eagerness of a customer to acquire DSL service. In a typical process, the line begins to be provisioned very soon after the DSL order is taken. The kit for the self-installation is shipped out at roughly the same time as the start of the line provisioning process. The kit, therefore, usually arrives at the customer's house before the DSL line is provisioned. This sequence of events leads to several adverse affects:

If the user does not pay close attention during the ordering process (or more likely, the person performing the installation the household is not the same as the person who ordered DSL), then they may not know what was the due date for the provisioning. This creates an installation problem: proceeding with an installation at this point results in a failed installation, and inbound calls to the DSL help desk.

In other cases, the service provider may miss the date for a number of reasons—in this case, even if the customer is aware of the due date, a failed installation will occur.

In still another case, the due date may be correct, and the customer may be aware of the due date, but the exact time of the turn-up is unknown, the customer knows the due date was Tuesday, for example, and tries the installation at 7:30 am. The service provider does the turn-up on Tuesday, but not until 10 am. Again, the customer has a failed installation, and the help desk must take a call.

Although DSL service providers typically remind the user about the due date in the ordering call, with a letter to the user and in the installation kit, customers still have difficulty with this part of the process. The present invention eliminates this kind of installation error by telling the user when it is appropriate to begin a DSL self installation.

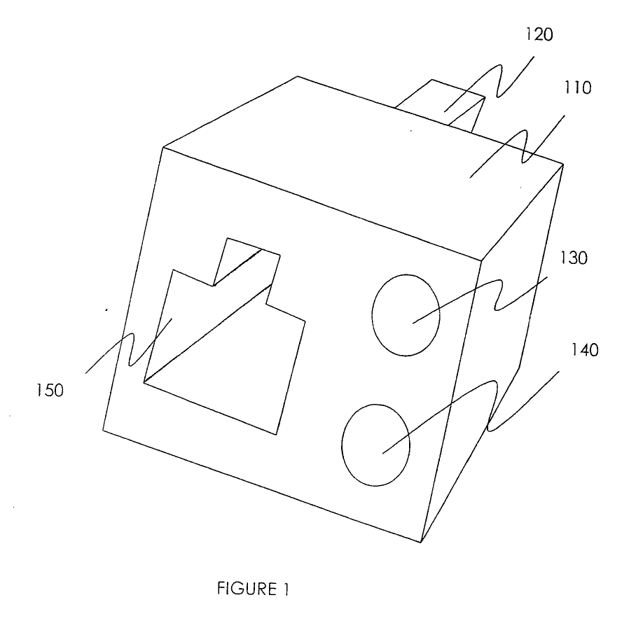

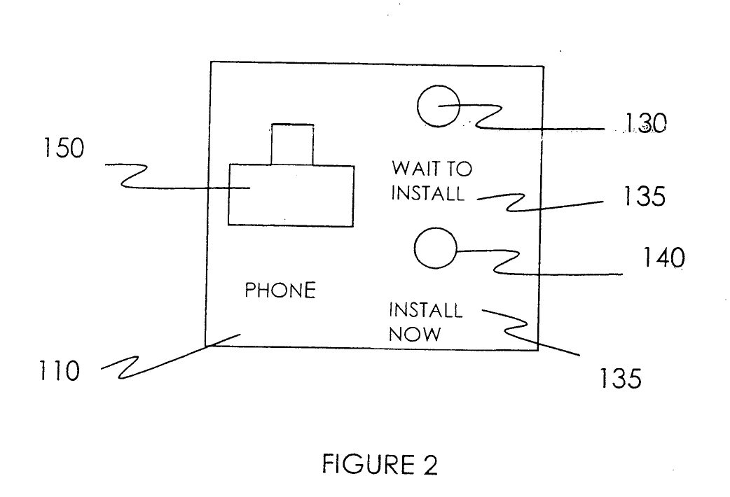

FIG. 1 is isometric schematic drawing of a DSL indicator of a specific embodiment of the present invention. Device 110, shown in FIG. 1, looks like a standard phone splitter, with one of the jacks removed. In its place are 2 LEDs, one red 130, one green 140. Although a typical user does not understand the concept of sync, the lights are labeled so that the user can determine if they can commence the installation (see FIG. 2).

The device plugs into a telephone jack with connector 120, and provides a pass through telephone port 150 so that a regular voice phone may be plugged into the same jack while the customer waits for the DSL sync indicator 140 to light up. The device has a simple low cost DSL sync detection mechanism (not shown) on board, that detects DSL sync. Any DSL detector, whether off-the-shelf or custom-made, is suitable for the present invention, provided that it is adaptable for use in the present invention. The device of FIG. 1 is sufficiently low cost that it may be treated as a disposable unit.

FIG. 2 is front view schematic drawing of the DSL indicator of FIG. 1. It is suggested that text 135 that accompanies indicator lights 130, 140 be very specific concerning installation status. For example, the text could read “WAIT TO INSTALL” 135 and “INSTALL NOW” 135.

The device of the depicted embodiment, in FIGS. 1 and 2, has a pass through phone port, so that the user can install the device and then leave it in a wall phone jack, for example, connected to their home phone if the “WAIT TO INSTALL” light was on. This advantageously allows the user to periodically check the status of the DSL while they retain phone service at that location.

Another labeling option for the indicator lights, which allows the device to be used in a more general DSL troubleshooting mode (in addition to its role as an installation tool), is to label the device with the words “NO DSL” and “DSL GOOD.” Such a label scheme helps the user determine if DSL is on the line in a more general sense, rather than in the confined context of a self-installation. In this scenario, the user retains the device for multiple uses over the life of their DSL line, if, for instance, the need arises that they have to troubleshoot the connection.

In specific embodiments, the device is included with the DSL self-installation kit and is used in the first step in any installation. An alternative embodiment ships it to the customer immediately upon order, so that it beats the self-installation kit to the user's house.

Having a simple DSL diagnostic tool is very valuable in two respects:

1) It reduces the number of calls to the DSL support center for failures associated with a non-provisioned line at the time of installation.

2) It gives the customer a vastly superior experience in the installation. They have high confidence that it was the right time to do the installation. If a customer tries to perform a DSL installation and the only reason it fails is due to a provisioning problem, the process can be quite frustrating. The user may attempt to perform all means of troubleshooting and spend time on the help line, only to be told to wait. When they know to wait at the beginning, the actual installation process proceeds smoothly.

Other embodiments of the invention integrate the DSL signal detection technology into a DSL wall filter. The integrated device filters, detects the presence of a DSL signal, and also indicates the DSL presence with the “No DSL”/“DSL Good” LEDs. In these embodiments, the DSL detection device is not a “throwaway,” but is retained by the customer for use as both a DSL filter and as a troubleshooting diagnostic device.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. A detector adapted to plug into a telephone jack, whereby the detector detects the presence of DSL sync and indicates the presence of DSL sync on a telephone line.

2. The detector of claim 1, wherein the detector is integrated in to a pass-through telephone port.

3. The detector of claim 1, wherein the detector is disposable.

4. The detector of claim 2, wherein the port is disposable.

5. The detector of claim 1, wherein the detector indicates the absence of DSL sync on the line.

6. The detector of claim 1, wherein the detector provides diagnostic information to trouble-shoot a DSL communication connection.

7. The detector of claim 1, wherein the detector comprises a wall filter.

8. The detector of claim 1, wherein the detector indicates whether or not to proceed with a DSL self-installation.

9. The detector of claim 1, wherein the detector is a component of a DSL self-install kit.

10. A DSL self-install kit, the kit comprising a DSL sync detector that indicates the presence of DSL sync on a telephone line as a condition precedent to DSL self-installation.

11. The kit of claim 10, wherein the detector is disposable.

12. The kit of claim 10, wherein the detector comprises a pass-through telephone port.

13. The kit of claim 12, wherein the port is disposable.

14. The kit of claim 10, wherein the detector is adapted to plug into a telephone jack.

15. The kit of claim 10, wherein the detector provides diagnostic information to trouble-shoot a DSL communication connection.

16. The kit of claim 10, wherein the detector indicates the absence of DSL sync.

17. The kit of claim 10, wherein the detector indicates whether or not to proceed with DSL self-installation.

18. A method for installing DSL, the method comprising:
detecting DSL sync on a telephone line prior to installing DSL; and
installing DSL.

19. The method of claim 18, further comprising:
providing a DSL sync detector;
providing a DSL installation kit comprising DSL hardware and software; and
provisioning DSL to subscriber.

20. The method of claim 18, wherein detecting DSL sync is performed by means of a disposable DSL sync detector adapted to plug into a telephone jack.
